(19) United States
(12) Patent Application Publication
(10) Pub. No.: US 2008/0015293 A1
(43) Pub. Date: Jan. 17, 2008

(54) HIGH ASSAY DECABROMODIPHENYL OXIDE

(75) Inventor: Bonnie Gary McKinnie, Magnolia, AR (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 11/775,750

(22) Filed: Jul. 10, 2007

Related U.S. Application Data
(60) Provisional application No. 60/830,038, filed on Jul. 11, 2006.

(51) Int. Cl. C08K 5/49

(52) U.S. Cl. 524/115; 252/601

(57) ABSTRACT

This invention relates to reaction-derived 99+% DBPDO flame retardant products that contain nonabromodiphenyl oxide in an amount not exceeding 0.5%.

### REFERENCE TO RELATED APPLICATION

This application claims the benefit and priority of U.S. Provisional Application No. 60/830,038, filed Jul. 11, 2006, the disclosure of which is incorporated herein by reference.

### BACKGROUND OF THE INVENTION

This invention relates to high assay decabromodiphenyl oxide products, and their use in flammable materials.

Decabromodiphenyl oxide (DBDPO) is a time-proven flame retardant for use in many flammable macromolecular materials, e.g., thermoplastics, thermosets, cellulosic materials and back coating applications.

DBDPO is presently sold as a powder derived from the bromination of diphenyl oxide in excess bromine and in the presence of a bromination catalyst, usually AlCl₃. The powdered products are not 100% DBDPO, but rather are mixtures that contain up to about 98% DBDPO and about 1.5%, or a little more, of nonabromodiphenyl oxide co-product. As an underbrominated product, this amount of nonabromodiphenyl oxide is considered problematic by some environmental entities.

It would therefore be desirable to provide for flame retardant products that contain (i) 99+% DBDPO and (ii) nonabromodiphenyl oxide in an amount not exceeding 0.5% and preferably not exceeding 0.1%.

### THE INVENTION

This invention relates to 99+% DBPDO flame retardant products that are derived from the bromination of diphenyl oxide or underbrominated diphenyl oxide and contain nonabromodiphenyl oxide in an amount not exceeding 0.5%.

Such flame retardant products can be said to be “reaction-derived” since they are reaction determined and not the result of downstream separation techniques, e.g., recrystallization to separate DBDPO from underbrominated diphenyl oxide co-products, e.g., nonabromodiphenyl oxide. Hereinafter the reaction-derived DBDPO flame retardant products of this invention will often be referred to simply as “DBDPO products of this invention.”

The DBDPO products of this invention preferably contain (i) DBDPO in an amount of at least about 99.5% and (ii) nonabromodiphenyl oxide in an amount not exceeding about 0.5%. Lesser amount of nonabromodiphenyl oxide are more preferred, say amounts not exceeding about 0.3% with amounts not exceeding about 0.1% being most preferred. Most highly preferred are nonabromodiphenyl oxide amounts not exceeding about 0.05%. The amount of the DBDPO constituent in the DBDPO products of this invention is preferably in excess of 99.5% and most preferably in excess of 99.9%. DBDPO amounts in excess of 99.95% are most highly preferred.

For the purposes of this invention, unless otherwise indicated, the % values given for DBDPO and nonabromodiphenyl oxide in the specification or claims are to be understood as being the area % values that are derived from gas chromatography analysis.

The gas chromatography is conducted on a Hewlett-Packard 5890 gas chromatograph using a 12QC5 HT5 capillary column, 12 meter, 0.15μ film thickness, 0.53 mm diameter, available from SGE, Inc., (SGE, Incorporated, 2007 Kramer Lane Austin Tex. 78758) part number 054657. Conditions were: 1:10 Split injection, column head pressure 9 psig (ca. 163.4 kPa), injector temperature 325° C., flame ionization detector temperature 350° C., and column temperature 300° C. isothermal. The carrier gas was helium. Samples were prepared by dissolving, with warming, 0.05 grams in 10 mL of dibromomethane and injection of 1 microliter of this solution. The integration of the peaks was carried out using Target Chromatography Analysis Software from Thru-Put Systems, Inc. However, other and commercially available software suitable for use in integrating the peaks of a chromatograph may be used.

Thru-Put Systems, Inc. is currently owned by Thermo Lab Systems. The address is 5750 Major Blvd., Suite 200, Orlando Fla. 32819.

The following Examples illustrate processes for producing the DBDPO products of this invention.

### EXAMPLE 1

A reactor was configured from a 1-liter Morton flask with mechanical stirrer, thermometer, 60 mL addition funnel, and fractionation column 10″×1″ (ca. 25.4 cm×ca. 2.5 cm) with 5 mm×5 mm Raschig rings topped by a reflux condenser. The outlet of the condenser connected to a H₂O trap. A small N₂ purge was added to the line from the condenser to the H₂O trap.

The reactor was charged with 3.5 g AlCl₃ and 1577 g bromine (11 ppm H₂O). The addition funnel was charged with 47.04 g diphenyl oxide. The reactor was heated to 55° C. and the diphenyl oxide was added drop-wise above the surface of the reactor contents. The time for the initiation of the diphenyl oxide addition was noted. The reactor was heated by a mantle. Twenty-seven minutes into the diphenyl oxide feed, half of the diphenyl oxide had been added and the reaction mass temperature was 56° C. One and a quarter hours after the diphenyl oxide feed was initiated, all of the diphenyl oxide had been added, and the reaction mass temperature was 57° C. The compressor on the refrigeration unit was shut off to allow slow warm-up of the condenser. The reaction mass was refluxed through the fractionation column. At one hour and 18 minutes the reaction mass temperature was 59° C. Two hours and three minutes after diphenyl oxide feed initiation, the condenser water was at 20° C. and the reaction temperature at 61° C. At two hours and seven minutes the condenser water was at 30° C. Thirty-two minutes later the addition funnel was replaced with the N₂ inlet. A slow N₂ purge of the reactor was started. The reaction mass temperature was 61° C. The N₂ purge was at 100 mL/min. into the vapor space of the reactor. Four hours and fifty minutes after the initiation of the diphenyl oxide feed, the reaction mass temperature was 61° C. and the condenser water was at 37° C. At six hours after the initiation of the diphenyl oxide feed the reaction mass was cooled to 55° C., 350 mL deionized H₂O was added, the fractionation column was removed and the reactor was set for distillation. Br₂ was distilled off. When most of the Br₂ was gone 150 mL more of deionized water were added. The remaining Br₂ was distilled off until the temperature of 100° C. was reached. The remaining mix was cooled to 60° C., and 30 mL 25% NaOH was added to pH 13-14. The resultant mix was filtered and washed well with deionized water. GC analysis of a sample showed 0.45%, 0.55% (duplicate analysis) of nonabromodiphenyl oxide in the sample. The sample was oven dried.

### EXAMPLE 2

In a 500 mL 4-neck flask with condenser, addition funnel, thermometer, and ⅛″ (ca. 0.32 cm) dip tube for take off was placed 437 g bromine. To this was added 48.6 g diphenyl oxide under reflux. All the diphenyl oxide was added in 45 minutes. 120 Grams more of bromine were added and the solution was refluxed at 63° C. under a 0° C. condenser for 30 minutes.

A 1-liter 4-neck equipped with mechanical stirrer, a 1/16″ (ca. 0.16 cm) O.D., 1/32″ (ca. 0.08 cm) ID dip tube, thermometer, a 9″×1″ (ca. 22.9 cm×ca. 2.5 cm) fractionation column (5 mm×5 mm Raschig ring) and topped by a 0° C. condenser, was charged with 4.03 of g AlCl₃ and 746 g of bromine. This mix was brought to reflux and the above previously prepared mixture pumped in at 1 mL/min. The resultant reaction mass was kept at reflux through the fractionation column with stirring at 200-300 rpm. The pump was a peristaltic pump using 0.8 mm I.D. Viton® polymer tubing in the pump. Reaction mass temperature was 59° C. At two hours and fifty six minutes after the initiation of the solution feed, the 500 mL flask was empty. 15 Grams of bromine were added to a 500 mL flask and this was pumped into the 1-liter flask also. Nitrogen at 100 mL/min, was then fed down the dip tube (subsurface) as the reaction mass was refluxed 1 hour longer. 500 mL of deionized water was then added, the fractionation column removed and the reaction set to distill bromine from the reaction mass. The bromine was distilled off until the temperature reached 100° C. and the remaining reaction mass was cooled to 60° C. 8 Grams of NaOH in 40 mL of water were added (pH 13-14). The mixture was filtered and H₂O washed giving a washed product. GC analysis showed 0.143% nonabromodiphenyl oxide. After oven drying overnight at 110° C. overnight, the dried product weighed 265 g. The 1/16″ (ca. 0.16 cm) OD dip tube described above was 0.8 mm I.D. and passed a 0.9 mL/min solution feed. This is equivalent to a linear velocity out of the tube of ≈0.1 ft/sec (ca. 3 cm/sec).

### EXAMPLE 3

In the 500 mL 4-neck flask of Example 2 was added 732 g of Br₂. Molten diphenyl oxide (49.3 g) was added dropwise at bromine reflux over 40 minutes. The solution was refluxed (0° C. condenser) 45 minutes longer.

To the 1-liter flask, equipped as in Example 2, was added 4.0 g of AlCl₃ and 595 g of bromine. This solution was brought to reflux through the fractionation column and the contents of the 500 mL flask pumped in at 0.5 mL/min via the 1/16″ (ca. 0.16 cm) OD, 1/32″ (ca. 0.08 cm) ID dip tube subsurface to the resulting reaction mass. The reaction mass temperature was 59° C. The reaction mass was kept at hard reflux throughout the solution addition. The temperature of the condenser cooling water was 17° C.

Eight hours later, all of the contents of the 500 mL flask had been pumped into the 1 liter flask. About 5 mL of bromine was added to the 500 mL flask and this pumped into the 1 liter flask. The reaction mass was then refluxed 15 minutes longer with a N₂ purge (about 100-200 ml/min) down the dip tube). The reaction mass was cooled partially, and 500 mL H₂O added and set for distillation. Bromine was distilled off until the temperature reached 100° C. and the reaction mass was cooled to 60° C. Excess 5% NaOH was added to pH 12. The solid product was collected and washed well with H₂O. A sample was analyzed by GC. GC showed 0.05% nonabromodiphenyl oxide and 99.95% decabromodiphenyl oxide. The remaining product was dried overnight at 130° C. and, after drying, weighed 263 g.

The DBDPO products of this invention are white or slightly off-white in color. White color is advantageous as it simplifies the end-user's task of insuring consistency of color in the articles that are flame retarded with the DBDPO products of this invention.

The DBDPO products of this invention may be used as flame retardants in formulations with virtually any flammable material. The material may be macromolecular, for example, a cellulosic material or a polymer. Illustrative polymers are: olefin polymers, cross-linked and otherwise, for example homopolymers of ethylene, propylene, and butylene; copolymers of two or more of such alkylene monomers and copolymers of one or more of such alkylene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g. high impact polystyrene, and styrene copolymers, polyurethanes; polyamides; polyimides; polycarbonates; polyethers; acrylic resins; polyesters, especially poly(ethyleneterephthalate) and poly(butyleneterephthalate); polyvinyl chloride; thermosets, for example, epoxy resins; elastomers, for example, butadiene/styrene copolymers and butadiene/acrylonitirle copolymers; terpolymers of acrylonitrile, butadiene and styrene; natural rubber; butyl rubber and polysiloxanes. The polymer may be, where appropriate, cross-linked by chemical means or by irradiation. The DBDPO products of this invention can be used in textile applications, such as in latex based back coatings.

The amount of a DBDPO product of this invention used in a formulation will be that quantity needed to obtain the flame retardancy sought. It will be apparent to those skilled in the art that for all cases no single precise value for the proportion of the product in the formulation can be given, since this proportion will vary with the particular flammable material, the presence of other additives and the degree of flame retardancy sought in any give application. Further, the proportion necessary to achieve a given flame retardancy in a particular formulation will depend upon the shape of the article into which the formulation is to be made, for example, electrical insulation, tubing, electronic cabinets and film will each behave differently. In general, however, the formulation, and resultant product, may contain from about 1 to about 30 wt %, preferably from about 5 to about 25 wt % DBDPO product of this invention.

It is advantageous to use the DBDPO products of this invention in combination with antimony-based synergists, e.g., Sb₂O₃. Such use is conventionally practiced in all DBDPO applications. Generally, the DBDPO products of this invention will be used with the antimony-based synergists in a weight ratio ranging from about 1:1 to 7:1, and preferably of from about 2:1 to about 4:1.

Any of several conventional additives used in thermoplastic formulations may be used, in their respective conventional amounts, with the DBDPO products of this invention, e.g., plasticizers, antioxidants, fillers, pigments, UV stabilizers, etc.

Thermoplastic articles formed from formulations containing a thermoplastic polymer and DBDPO product of this invention can be produced conventionally, e.g., by injection molding, extrusion molding, compression molding, and the like. Blow molding may also be appropriate in certain cases.

1. A reaction-derived decabromodiphenyl oxide flame retardant product containing: (i) 99+% decabromodiphenyl oxide and (ii) nonabromodiphenyl oxide in an amount not exceeding about 0.5%.

2. The product of claim 1 wherein the nonabromodiphenyl oxide does not exceed 0.3%.

3. The product of claim 1 wherein the nonabromodiphenyl oxide does not exceed 0.1%.

4. The product of claim 1 wherein the nonabromodiphenyl oxide does not exceed 0.05%.

5. A flammable macromolecular material containing a flame retardant amount of a reaction-derived flame retardant product that is 99+% DBDPO and contains nonabromodiphenyl oxide in an amount not exceeding about 0.5%.

6. The material of claim 5 wherein the macromolecular material is a thermoplastic a thermoset or a latex-based back coating.

7. The material of claim 5 or 6 wherein the nonabromodiphenyl oxide content does not exceed about 0.5%.

8. The material of claim 5 or 6 wherein the nonabromodiphenyl oxide content does not exceed about 0.3%.

9. The material of claim 5 or 6 wherein the nonabromodiphenyl oxide content does not exceed about 0.1%.

10. The material of claim 5 or 6 wherein the nonabromodiphenyl oxide content does not exceed about 0.05%.
